(19) United States
(12) Patent Application Publication
(10) Pub. No.: US 2011/0267441 A1
(43) Pub. Date: Nov. 3, 2011

(54) 3-D MOVING PICTURE VIEWING APPARATUS

(76) Inventors: Yan Yan Lee, Hong Kong (HK); Hoi Ming Chan, Hong Kong (HK)

(21) Appl. No.: 12/770,228

(22) Filed: Apr. 29, 2010

(51) Int. Cl. H04N 13/04; G02F 1/1335; G02B 27/22

(52) U.S. Cl. 348/56; 359/464; 349/15; 348/E13.075

(57) ABSTRACT

A 3-D viewing apparatus for viewing moving pictures, the apparatus comprising a left-channel viewer and a right-channel viewer respectively for viewing by left-eye and right-eye of a user, and an electronically controlled shutter mechanism which is arranged to alternatively shut the left-channel viewer and the right-channel viewer such that a user only sees the left- and right- channels through the left- and right viewers respectively. The shutting frequency of the shutter mechanism is predetermined or preset by an electronic controller. The 3-D viewing glass has a shutting mechanism which is arranged to shut the left- and right-viewers at a predetermined, preset or pre-programmed means there is no need to extract electronic synchronization signals from the video source and this makes the 3-D viewing glass more economical and more convenient to use.

### FIELD OF THE INVENTION

The present invention relates to moving picture apparatus and more particularly, to viewing apparatus for viewing moving pictures with 3-D effects. More specifically, although not solely limited thereto, the present invention relates to 3-D viewing glass for visualizing 3-D effects on an LCD screen.

### BACKGROUND OF THE INVENTION

Moving pictures which convey 3 dimensional (“3-D”) or stereoscopic visual effects to viewers are gaining increasing popularity. Such 3-D visual effects are possible, even though the pictures are typically formed on a plain and planar screen, because the image captured by the left-eye and the right-eye of a human viewer is different. Moving pictures which are arranged to convey 3-D visual effects to viewers usually comprise left-channel and right-channel pictures which are projected, for example, alternatively or sequentially, on a plain screen. 3-D viewing effects are then visualized by a viewer by wearing a 3-D viewing apparatus, and such viewing apparatus are more commonly known as 3-D glasses. In general, 3-D viewing apparatus are arranged such that the left- and right-channel images are captured respectively by the left and right eyes of a viewer, and the different images collected by the left and right eyes are merged by the viewer to produce calculated 3-D effects.

There are two main types of 3-D glasses, namely, the polarizer type and the shutter type. The polarizer type 3-D glasses has been available for a relatively long time and is adapted for viewing 3-D movies in which the left- and right-channel images are orthogonally polarized so that the orthogonally polarized left- and right-channel images are picked up separately and respectively by the left and right eyes for subsequent 3-D effect formation. However, the polarized type 3-D glasses are not suitable for screens comprising liquid crystal displays (“LCD”) because a normal LCD screen is already polarized, unless micro-polarizers are used.

The shutter type 3-D glass is customized for viewing 3-D moving pictures in which the left- and right-channel pictures are alternatively and sequentially projected onto a plain screen. The shutter type 3-D glasses typically comprises left- and right-lenses of liquid crystal cells and electronic shutters which are operated to shut the left lens and the right-lens so that only left channel images are picked up by the left eye, and right channel images are only picked by the right eye. Because the right and right lenses of a shutter type 3-D glass are operated to shut and open alternately and in synchronous with the left- and right-channel images, conventional shutter type 3-D glasses, such as those described in U.S. Pat. No. 6,687,399, U.S. Pat. No. 6,791,599 and US 2001/0038491, typically require synchronization signals from the moving image source to operate the shutters. Such requirements are somewhat restrictive and expensive for many applications because a wired or wireless signal connection means would be required to deliver the video electronic signals to the 3-D glass.

Therefore, it would be desirable if improved shutter type 3-D glasses are available.

### SUMMARY OF THE INVENTION

According to the present invention, there is provided a 3-D viewing apparatus for viewing moving pictures, the 3-D moving picture comprising alternate displaying on a screen of images corresponding to left-channel and right-channel pictures, the left-channel and right-channel images being for combining by a viewer to perceive a 3-D sense, wherein the apparatus comprises a left-channel viewer and a right-channel viewer respectively for viewing by left-eye and right-eye of a user, and an electronically controlled shutter mechanism which is arranged to alternatively shut the left-channel viewer and the right-channel viewer such that a user only sees the left- and right-channels through the left- and right viewers respectively; and wherein the shutting frequency of the shutter mechanism is predetermined or preset by an electronic controller.

A 3-D viewing glass having a shutting mechanism which is arranged to shut the left- and right-viewers at a predetermined, preset or pre-programmed means there is no need to extract electronic synchronization signals from the video source and this makes the 3-D viewing glass more economical and more convenient to use.

The shutter mechanism may be controlled by the electronic controller which is adapted to shut the left- and right-viewers alternately at the shutting frequency, the shutting frequency being preset in the controller. For example, the shutting frequency may be preset to be compatible with that of typical or standard number of frames-per-second for 3-D video images.

### BRIEF DESCRIPTION OF THE FIGURES

Embodiments of the present invention are described below by way of example and with reference to the accompanying Figures in which:

FIG. 1 is a schematic perspective view of a 3-D viewing glass incorporating an embodiment of the present invention,

FIG. 2 is a schematic block diagram depicting various functional blocks of the viewing glass of FIG. 1 and their inter-relationship,

FIG. 3 is a schematic circuit block diagram depicting circuit arrangement of the viewing glass of FIG. 1,

FIG. 4 is a circuit diagram depicting a circuit embodiment for the circuit of

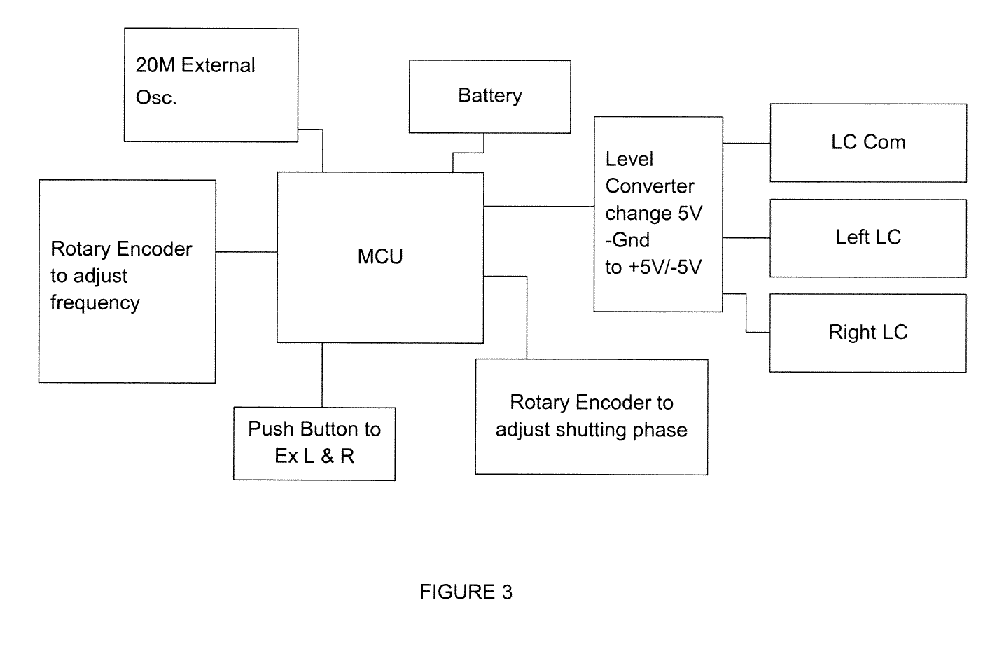

FIG. 3,

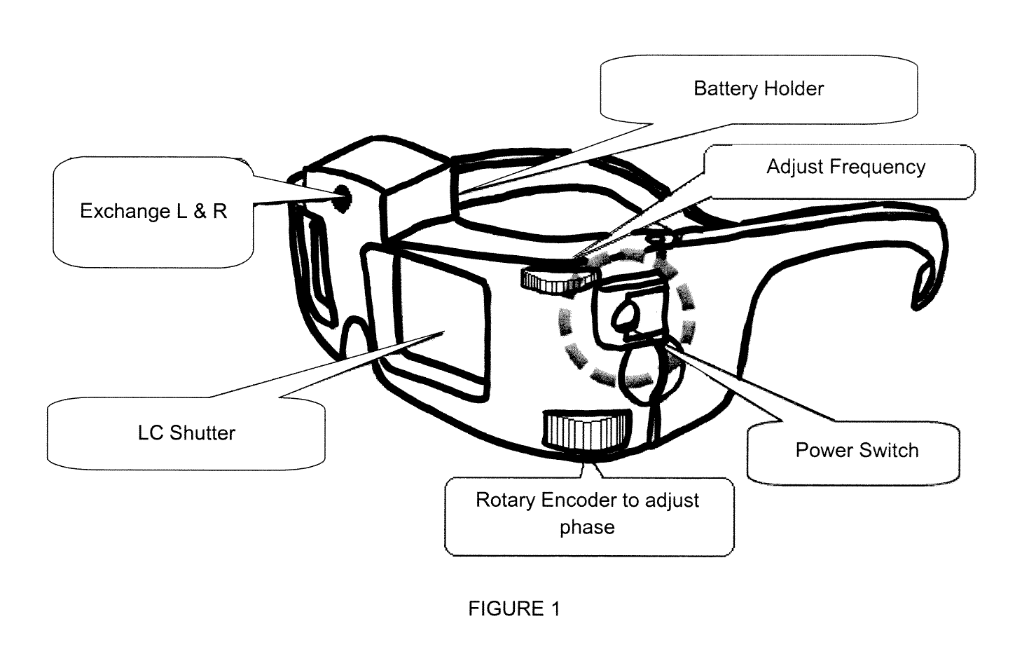

FIG. 5 is a diagram showing timing relationship between the various control signals of the viewing glass of FIG. 1, and

### DETAILED DESCRIPTION OF THE INVENTION

The 3-D viewing glass of FIG. 1 illustrates an example of a 3-D viewing apparatus for viewing moving pictures and comprises a pair of liquid crystal lens which are mounted on a rigid eyewear frame to operate respectively as a left-channel viewer and a right-channel viewer. The eyewear frame is moulded of hard plastics and comprises a front housing on which a left-window and a right-window respectively for mounting the left and right lenses are formed, and on which a compartment for receiving a control mechanism as an example of a shutter control mechanism is formed. Rotary switches as examples of means for controlling the shutter operating frequency and means for actuating the shutting phase are provided on the front housing, and their operation will be described in more detail below. In order to facilitate a reversal of images to be captured by the left- and right eyes, a reversal switch is provided on the front housing to permit a user to switch the shutter control mechanism so that the left-viewer and right-viewer could be configured to view the right-channel and left-channel images respectively so that a user could experience a reversal of visual effects so that the left eye sees the right channel and vice versa. As an optional feature, the reversal switch could be further configured to facilitate selective viewing of only the left-channel or only the right-channel images when a viewer is desirous to view a 2-D, or non-stereoscopic, version of the moving picture.

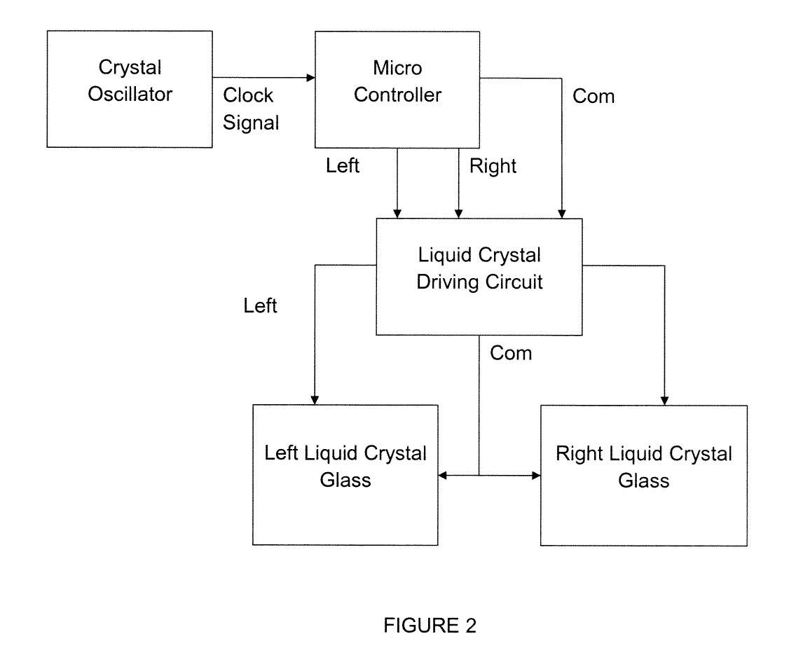

The circuit block diagram of FIG. 2 depicts an exemplary electronic arrangement to facilitate high-speed electronic shutting of the liquid crystal lenses. Referring to FIG. 2, the electronic arrangement comprises a microcontroller which is arranged to generate shutting and/or opening signals to operate a liquid crystal (“LC”) driving circuit. The LC driving circuit is arranged to receive and process the controlling signals, that is, the shutting and/or opening signals, generated by the microcontroller and to generate control signals compatible with LC lens control. In particular, the LC driving circuit comprises “Left” and “Right” inputs for receiving control signals from the microcontroller, and “Left”, “Right” and “Corn” (common) outputs for controlling the LC lenses. The Corn signal is a common output which is fed to both the left- and right- LC lenses to change the Left & Right Signal from DC signal to AC signal to protect the LC lenses, since a lens of liquid crystals requires AC voltage to operate. The Left- and Right-outputs of the liquid crystal driving circuit are fed to the left- and right-lenses respectively to cause the left- and right- lenses to open and shut.

In order to operate the lens shutting mechanism without dependency on the electronic signals generating the video images, the microcontroller is preset or preprogrammed with a plurality of shutting frequencies, for example, at 60, 75, 80, 85, 100, 120, etc Hertz, or appropriate shutting frequencies compatible with the moving picture displaying frequencies.

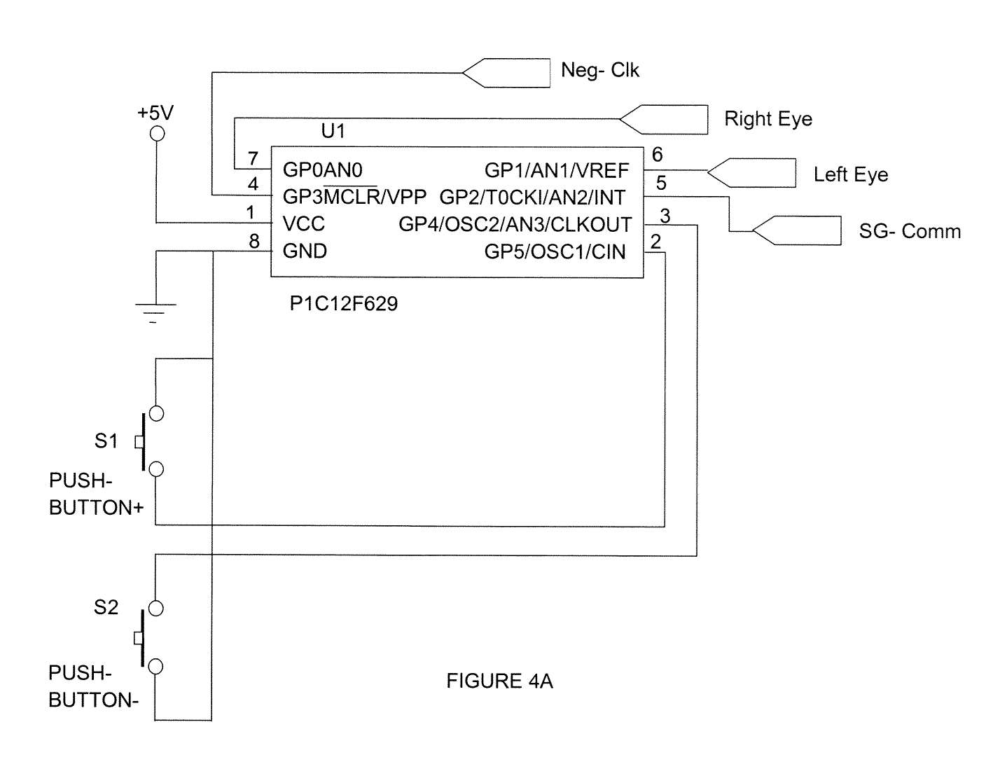

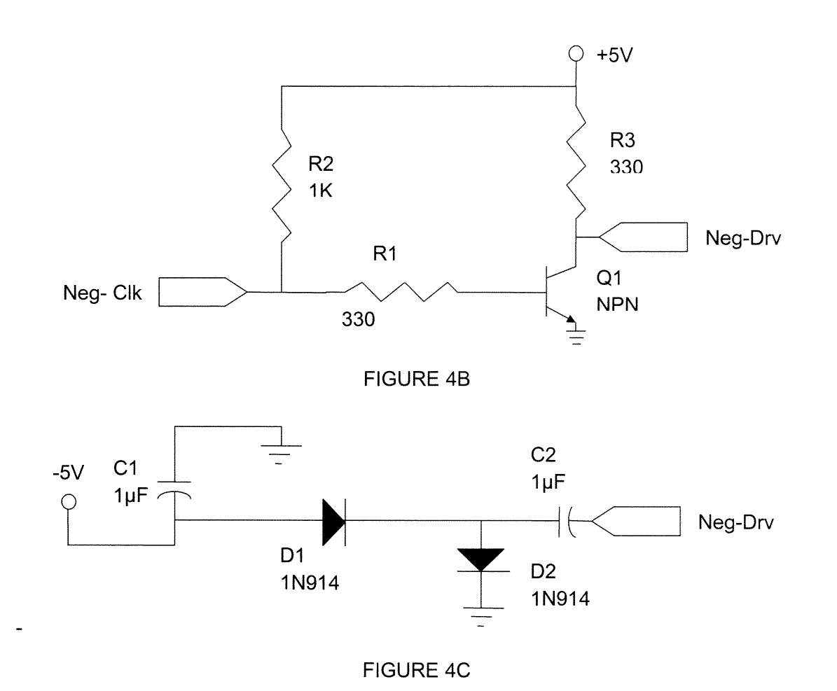

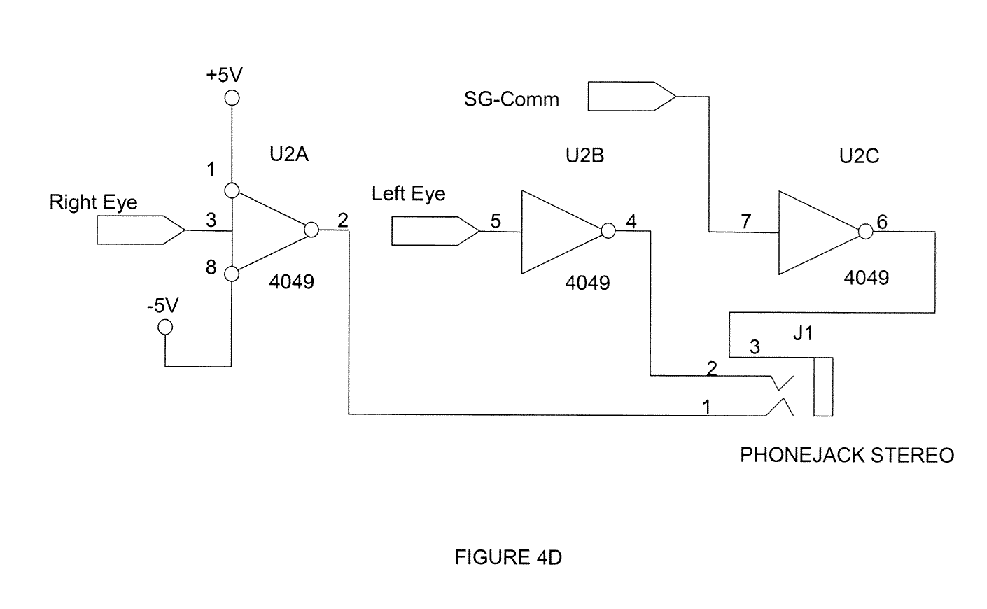

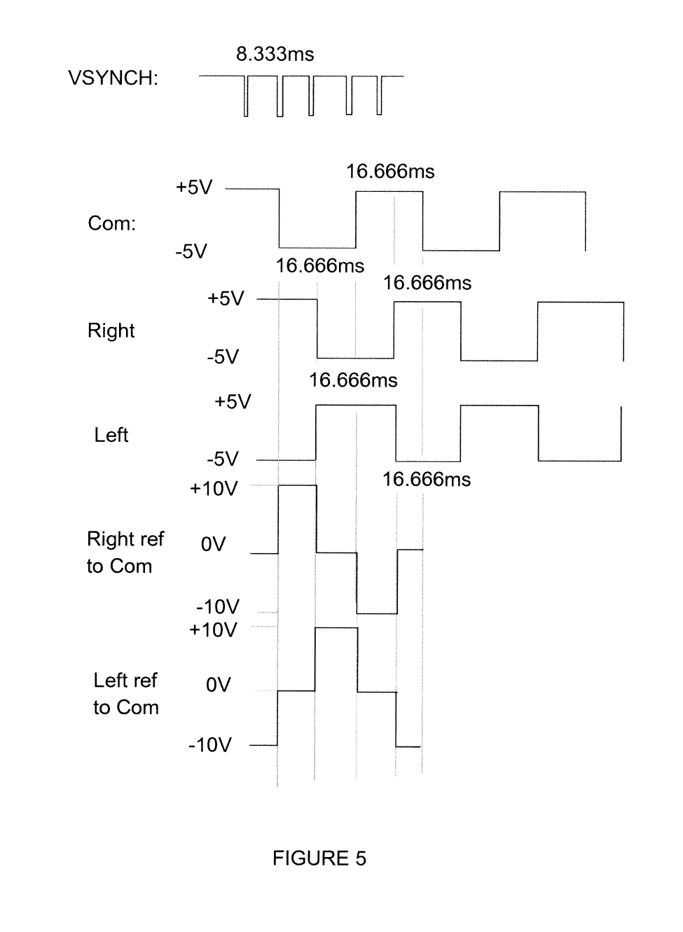

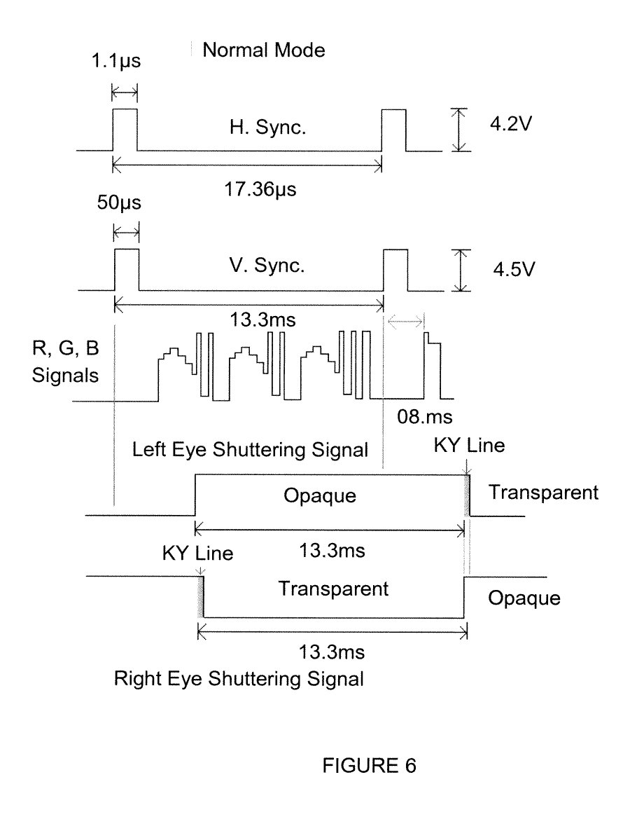

FIG. 5 illustrate timing diagrams of the shutter control mechanism for video images on a VGA monitor at a vertical synchronous signal frequency of 120 Hz, corresponding to a period of 8.3333 ms. Each of Left-, Right-, and Com-outputs comprises a control signal train of square pulses having the same amplitude of ±10V, an “On” duration of 1/F, and an “OFF” (0V) duration of 1/F, where F is the shutting frequency. Since the video images are interlaced, the shutting frequency of the shutter mechanism of this 120 Hz. It will be noted that the Right- and Left- signals with reference to Com signal will be alternated between +10V, OV and −10V, when the Left- and Right-lenses are arranged to be shut alternately for viewing the Left- and Right-channels respectively. In other words, the Left- and Right-signals are shutting off at 0V and turn on at ±10V in this instance. The circuit of FIG. 4 depicts an inverter to ensure this out-of-phase relationship.

It will also be appreciated that when the Left- and Right-lenses are arranged to be shut alternately for viewing the Right- and Left-channels respectively, the “ON” (±10V) and “OFF” (0V) of the Left- and Right-channel signal phases will be reversed. Furthermore, the Left- and Right-channel signals could be set to be in phase where a viewer wishes to only view a 2-D or non-stereographic version, for example, to selectively view either the Right-channel or the Left-channel. A switch is provided on the eyewear to enable a user to make the choice, and this switch is connected to the microcontroller to inform the microcontroller of the user's choice in order to generate the appropriate control signal trains.

Since the 3-D glass is adapted to operate to synchronize with the pictures in display but without obtaining electronic synchronization signals from the video source, the shutting frequency has to be very accurate, otherwise the moving pictures will be visualized as vertically running. In the exemplary circuitry of FIG. 3, a 20 MHz microcontroller with a 0.05 μs instruction cycle is connected to ensure high shutting frequency fidelity. Such a high frequency oscillator is employed in this example to provide fidelity of less than 1 frame deviation for a 10-minute video which requires the clock of the micro-controller to operate at least at 8.64 MHz.

The reasons for this oscillator frequency are as follows. There are 60 frames per second. If the target is to make 1 frame deviation of a 10 minutes video, then the accuracy will be 1/(60*60*10)=0.00002777. In order to generate an accurate frequency to meet the requirement, or internal operation cycle will be 60 HZ/0.00002777=2,160,060.5 HZ=2.16 MHZ, since the exemplary microcontroller needs 1 clock for one instruction, and at least 4 instructions are required to count so the clock for the microcontroller will be 4×2.16 MHZ=8.64 MHZ. In order to make a better performance, a 20 MHZ crystal oscillator is used to generate the clock for the microcontroller. In the present arrangement, gross frequency control is selected by a user and then fine frequency control is adjustable by a user by way of a rotary switch.

The operation of the 3-D glass will be described below. Firstly, a user selects the frequency of operation. This is selected by choosing a pre-set frequency which displays the minimum rate of running pictures. The shutting frequency is then fine tuned by the rotary switch. After the shutting frequency has been fully set, the phase will have to be adjusted to synchronize with that of the moving pictures. When the phase relationship is not correct, a portion of the image will be lost and this often appears as a dim area or a black line on the screen, as shown in FIG. 6. By adjusting the actuation or triggering the shutting phase of the shutting mechanism, for example, by turning the rotary phase adjustment switch, the dim area or the black line (corresponding to a phase error) will be moved upwards or downwards on the screen until it finally disappears.

While the present invention has been explained with reference to the embodiments above, it will be appreciated that the embodiments are only illustrative of the invention and provides examples of implementation and are not meant to restrict the form of implementation of the invention. For example, while switches corresponding a plurality of shutting frequency are provided, the number and value of preset frequencies are optional and may depend on standards of 3-D broadcasting once available.

1. A 3-D viewing apparatus for viewing moving pictures, the 3-D moving pictures comprising alternate displaying of images corresponding to left-channel and right-channel pictures, the left-channel and right-channel images being for combining by a viewer to perceive a 3-D sense, wherein the apparatus comprises a left-channel viewer and a right-channel viewer respectively for viewing by left-eye and right-eye of a user, and an electronically controlled shutter mechanism which is arranged to alternatively shut the left-channel viewer and the right-channel viewer such that a user only sees the left- and right channels through the left- and right viewers respectively; and wherein the shutting frequency of the shutter mechanism is predetermined or preset by an electronic controller.

2. A viewing apparatus according to claim 1, wherein the shutter mechanism is controlled by the electronic or microcontroller controller which is adapted to shut the left- and right-viewers alternately at the shutting frequency, the shutting frequency being preset in the controller.

3. A viewing apparatus according to claim 2, wherein the shutting frequency is selectable or adjustable by a user.

4. A viewing apparatus according to claim 1, wherein the shutting frequency is selectable or adjustable by a user.

5. A viewing apparatus according to claim 4, wherein the shutter mechanism is controlled by a microcontroller and the shutting frequency is not extracted electronically from the moving picture video source.

6. A viewing apparatus according to claim 1, wherein the shutter mechanism is controlled by a microcontroller and the shutting frequency is not extracted electronically from the moving picture video source.

7. A viewing apparatus according to claim 6, wherein the controller is arranged such that the shutter frequency is selectable by a user operable switch on the apparatus.

8. A viewing apparatus according to claim 1, wherein the controller is arranged such that the shutter frequency is selectable by a user operable switch on the apparatus.

9. A viewing apparatus according to claim 1, wherein the screen comprises a liquid crystal display and each of the viewer comprises a lens of liquid crystal cells.

10. A viewing apparatus according to claim 1, wherein the shutter mechanism is operated by control signals which are independent of electronic video signals generating the pictures.

11. A viewing apparatus according to claim 1, wherein the shutting frequency of the shutter mechanism is generated by an oscillator having an oscillation frequency higher than that of the shutting frequency.

12. A viewing apparatus according to claim 11, wherein the shutting frequency of the shutter mechanism is in the region of tens to hundreds hertz and the oscillator frequency is in the megahertz region.

13. A viewing apparatus according to claim 1, wherein the shutter mechanism comprises a phase adjustment device to control timing or phrase of viewer shutting.

14. A viewing apparatus according to claim 13, wherein the phase adjustment device is adapted for manual adjustment by a user with reference to visual indicia on the screen.

15. A viewing apparatus according to claim 14, wherein the phase adjustment device is adapted for aligning the shutter phase to operate with respect to vertical blank out period of video signals forming the moving pictures.

16. A viewing apparatus according to claim 13, wherein the phase adjustment device is adapted for aligning the shutter phase to operate with respect to vertical blank out period of video signals forming the moving pictures.

17. A viewing apparatus according to claim 13, wherein the shutter mechanism comprises a switch which is arranged to permit a user to selectively operate the left-channel viewer and the right-channel viewer so that the left-channel viewer and the right-channel viewer is arranged to view the right-channel and left-channel images respectively.

18. A viewing apparatus according to claim 1, wherein the shutter mechanism comprises a switch which is arranged to permit a user to selectively operate the left-channel viewer and the right-channel viewer so that the left-channel viewer and the right-channel viewer is arranged to view the right-channel and left-channel images respectively.

19. A viewing apparatus according to claim 18, wherein left- and right-audio channels are arranged to be transmitted wirelessly to the apparatus.

20. A viewing apparatus according to claim 18, wherein the shutter mechanism comprises a switch which is arranged to permit a user to selectively operate the left-channel viewer and the right-channel viewer so that both the viewers are adapted for viewing either the left-channel images or the right-channel images.

21. A viewing apparatus according to claim 1, wherein the shutter mechanism comprises a switch which is arranged to permit a user to selectively operate the left-channel viewer and the right-channel viewer so that both the viewers are adapted for viewing either the left-channel images or the right-channel images.
